(19) United States
(12) Patent Application Publication
(10) Pub. No.: US 2024/0032480 A1
(43) Pub. Date: Feb. 1, 2024

(54) PLANT STEM CUTTING ASSEMBLY

(71) Applicant: Josh Criss, Valencia, CA (US)

(72) Inventor: Josh Criss, Valencia, CA (US)

(21) Appl. No.: 17/876,130

(22) Filed: Jul. 28, 2022

(51) Int. Cl. A01G 3/02

(52) U.S. Cl. CPC A01G 3/02; A01G 2003/023

(57) ABSTRACT

A plant stem cutting assembly is provided. The cutting assembly includes a pair of shears (also referred to as scissors) equipped with a plant stem holding device. The plant stem holding device is coupled to a first blade of the shears and includes a channel adapted to secure the stem of the plant at a predefined angle with respect to the first blade. In this way, a user may place the stem of the plant into the stem holding device and easily cut the stem at the desired angle.

### CROSS-REFERENCE TO RELATED APPLICATIONS

This application claims priority to U.S. Provisional Application No. 63/226,955, filed on Jul. 29, 2021, the entire contents of which are hereby fully incorporated herein by reference for all purposes.

### FIELD OF THE INVENTION

This invention relates to cutting devices, including cutting devices with a plant stem holder at a preset angle.

### BACKGROUND

It is a well-known practice in the agriculture and botany industries to trim the stems of flowers and buds at an offset angle with respect to the longitudinal length of the stem when harvesting and pruning. One purpose for this is that an angled cut provides greater surface area and a corresponding increased water uptake for the harvested plant. For example, flowers with stems cut at a 45° tend to last longer in water for flower arrangements compared to flowers cut at a right angle. In addition, cutting stems at an angle during pruning promotes faster healing of the pruned plant compared to cutting at a right angle (cuts that are flat or nearly flat tend to collect water which may lead to decay).

However, it is oftentimes difficult to manually cut the stem of a plant at a 45° angle given that this requires one to approximate the angle of the shears while holding the plant stem secure during the cut.

Accordingly, there is a need for a cutting tool that holds the stem of a plant at a desired angle while facilitating the easy cut of the plant. The presently disclosed assembly addresses these needs.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a pair of standard shears (prior art) according to exemplary embodiments hereof;

FIGS. 2-4 show aspects of a plant stem cutting assembly according to exemplary embodiments hereof;

FIG. 5 shows a plant stem holder according to exemplary embodiments hereof;

FIGS. 6A-6C show aspects of a single-sided plant stem holder configured with a cutting blade according to exemplary embodiments hereof;

FIGS. 7A-7C show aspects of a double-sided plant stem holder configured with a cutting blade according to exemplary embodiments hereof; and

FIGS. 8A-8B show aspects of a double-sided plant stem holder configured with a cutting blade according to exemplary embodiments hereof.

### DETAILED DESCRIPTION OF EXEMPLARY EMBODIMENTS

In general, and according to exemplary embodiments hereof, a plant stem cutting assembly is provided. In some embodiments, the cutting assembly includes a pair of shears (also referred to as scissors) equipped with a plant stem holding device. The plant stem holding device is configured with one or both blades of the shears and includes a channel adapted to secure the stem of the plant at a predefined angle with respect to the shear's blade(s). In this way, a user may place the stem of the plant into the stem holding device and easily cut the stem at the desired angle.

This specification will start with an overview of shears to provide background information, followed by a detailed description of the plant stem cutting assembly of the present invention.

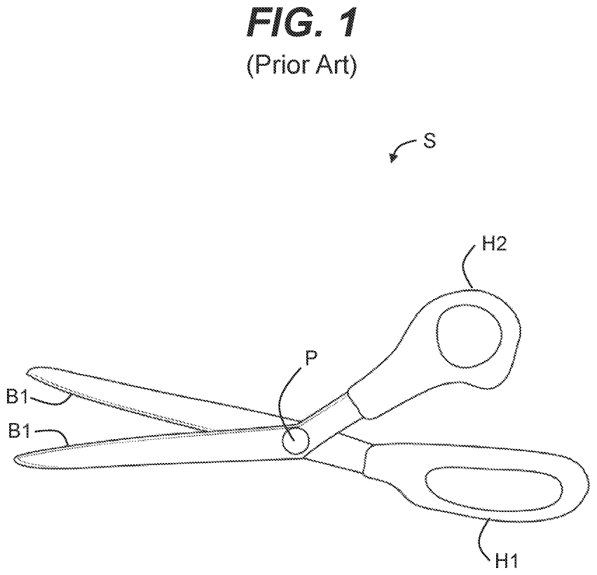

As is known in the art and as shown in FIG. 1, shears S (and scissors, which are sometimes smaller) comprise a pair of opposing metal blades B1, B2 configured to rotate with respect to one another about a pivot point P (a rivet or screw connection between the blades). Handles H1, H2 are configured on the opposite ends of the blades for a user to grasp. In this configuration, the blades B1, B2 are configured to meet and cut when the handles H1, H2 at the opposite ends are brought together. Some shears include a C-shaped spring connection at the handle ends and are therefore described as spring shears.

In some designs, the two blades B1, B2 are made to twist or curve slightly toward one another so that the blades B1, B2 may only touch one another in two places: (i) at the pivot point, and (ii) at the point along the blades B1, B2 where the cutting occurs.

Specialized shears for particular purposes also are popular. For example, pruning shears are a type of shear used for cutting plant materials. Anvil pruning shears include a single blade that closes onto a flat surface. Bypass pruning shears typically function similar to standard shears, but with at least one of the blades being curved, e.g., with a convex upper blade and either a concave or straight lower blade. Parrot-beak pruning shears consist of two concave passing blades, which trap the stem between the blades while the cut is made.

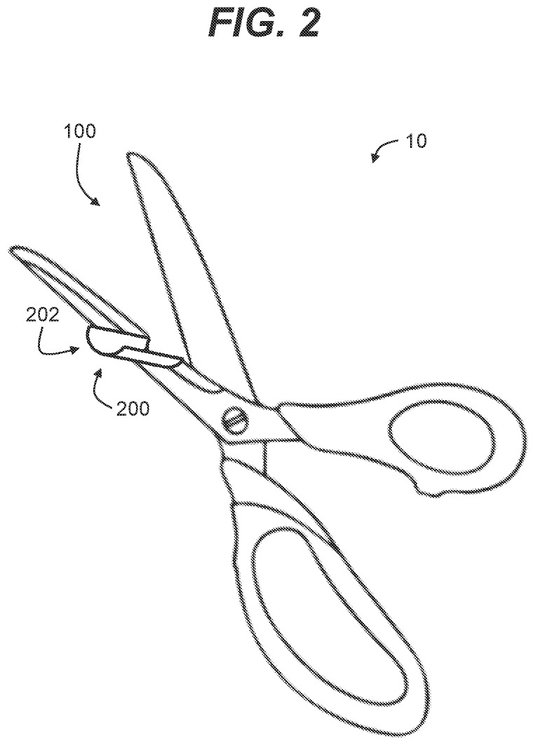

In one exemplary embodiment hereof, as shown in FIG. 2, the plant stem cutting assembly 10 includes a cutting device 100 and plant stem holding mechanism 200. In general, the plant stem holding mechanism 200 is used to hold the stem of a plant, and the cutting device 100 is used to make the cut. The plant stem cutting assembly 10 also may include other elements and/or components as necessary to perform its functionalities.

For the purpose of this specification, the plant stem cutting assembly 10 will be described predominantly as including a cutting device 100 resembling a pair of shears configured with the plant stem holding mechanism 200. However, it is understood that the plant stem cutting assembly 10 may include any type of cutting instrument (e.g., any variant of shears) and that the scope of the assembly 10 is not limited in any way by the type(s) of cutting instrument(s) that it may include. It also is understood that the plant stem cutting assembly 10 may be used to cut other items that may benefit from its functionalities in addition to plant stems and that the scope of the assembly 10 is not limited in any way by the item(s) that it may be used to cut.

Cutting Device 100

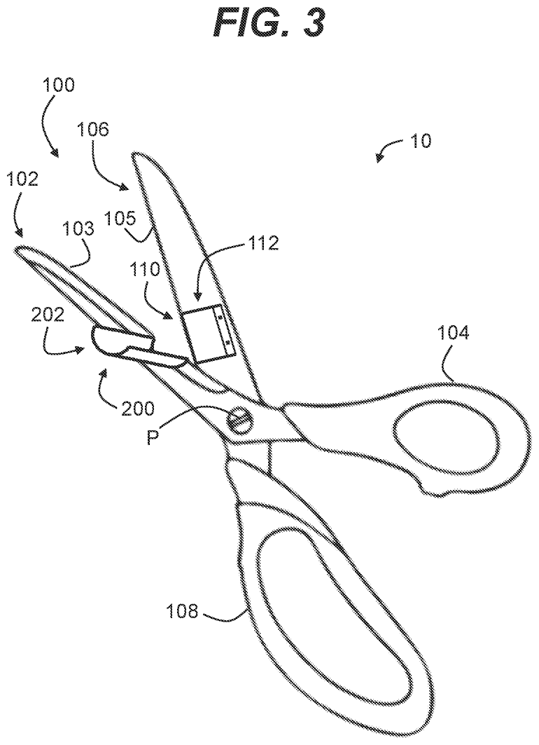

In some embodiments as shown in FIG. 3, the cutting device 100 includes a first blade 102 with a first handle 104 rotatably configured about a pivot point P1 with a second blade 106 with a second handle 108. The first blade 102 includes a first cutting edge 103 and the second blade 106 includes a second cutting edge 105.

In some embodiments, the first blade 102 and the second blade 106 are configured as a pair of shears as described above. Accordingly, the blades 102, 106 and corresponding cutting edges 103, 105, respectively, are designed to come into contact at a cutting point during use.

In some embodiments, as shown in FIG. 3, the second blade 106 includes a removable cutting edge portion 110 configured with the blade 106 at the cutting point and adapted to provide a sharpened cutting edge for cutting the plant stem. The removable cutting edge 110 may be used in conjunction with the plant stem cutting assembly 10 until dull, and then removed for resharpening and/or for replacement with a new removable cutting edge 110. In other embodiments, the removable cutting edge 110 is omitted and the second cutting edge 105 extends in its place (at the cutting point) for use in cutting the plant stem.

In some embodiments, the removable cutting edge 110 includes a razor blade or other type of removable blade that may be secured to the blade 106. The blade 106 may include a holder 112 (e.g., a recess or other type of receptacle) adapted to receive the removable cutting edge 110 and to hold it in proper alignment with the blade 106 so that its edge may be engaged as the assembly's 10's cutting edge when the overall assembly 10 is utilized. As will be described in other sections, it is preferable that the cutting edge of the removable cutting edge 110 engages the plant stem to be cut in the region of the plant stem holding mechanism 200 during use.

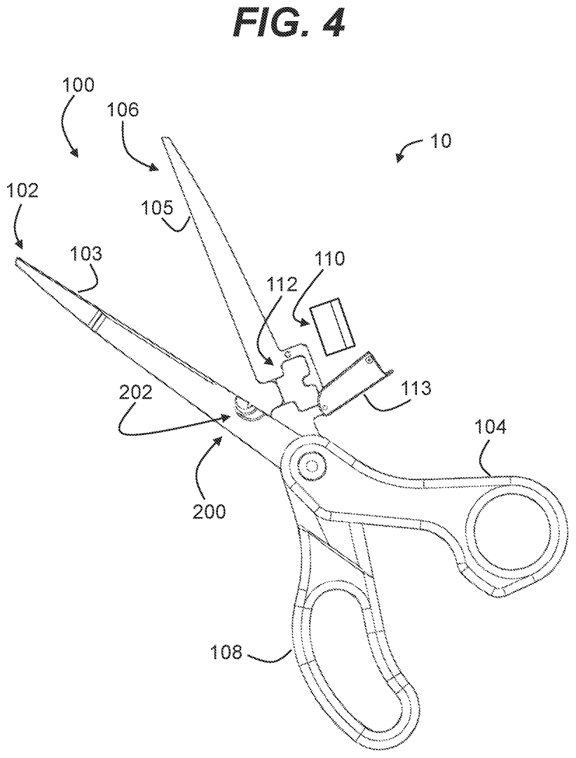

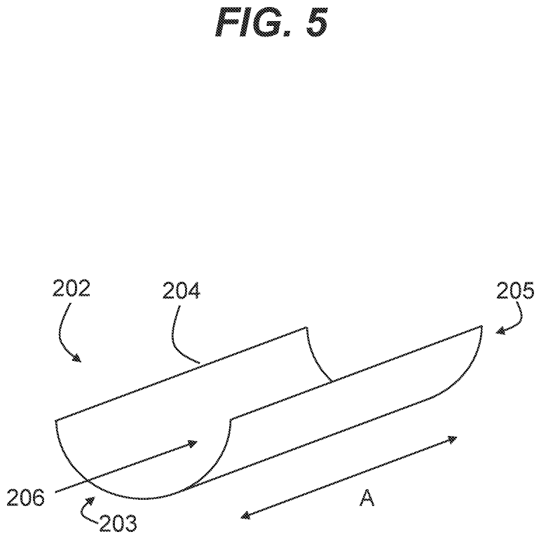

In some embodiments, as shown in FIG. 4, the holder 112 includes a locking mechanism 113 that may pivot upward to release the removable cutting edge 110. FIG. 4 shows the locking mechanism 113 rotated upward and the removable cutting edge 110 (e.g., the razor blade) removed from the assembly Once the removable cutting edge 110 is placed within the holder 112, the locking mechanism 113 may be rotated back downward to lock the removable cutting edge 110 in place. In this way, the removable cutting edge 110 may be locked in its holder 112 by the locking device 113.

It also is contemplated that the removable cutting edge 110 may be attached to the blade 106 (e.g., to the holder 112) using small screws, clips, latches, detents, side notches, pressure fit, other types of attachment mechanisms, and any combinations thereof.

Plant Stem Holding Mechanism 200

In some embodiments as shown in FIG. 2, the plant stem holding mechanism 200 includes a stem holder 202 configured with the first blade 102 of the cutting device 100.

In some embodiments as shown in FIG. 4, the stem holder 202 includes an elongate body 204 with a first end 203 (e.g., a left end) and a second end 205 (e.g., a right end) defining a longitudinal axis A. In addition, the body 204 includes an upper channel 206 extending between the first end 203 and the second end 205 in the direction of the longitudinal axis A. In some embodiments the upper channel 206 includes a curvature (e.g., an upward facing concave curvature) designed to receive a stem of the plant being cut. In some embodiments, the curvature is formed as a half-round tube with an open top (also referred to as a half-round channel and/or a half pipe). While the channel 206 is shown as including a generally half-circular cross-sectional shape (curvature), the channel 206 may include other cross-sectional shapes (curvatures) including, but not limited to, U-shaped, V-shaped, rectangular, inverted trapezoidal, oval, other suitable shapes, and any combinations thereof.

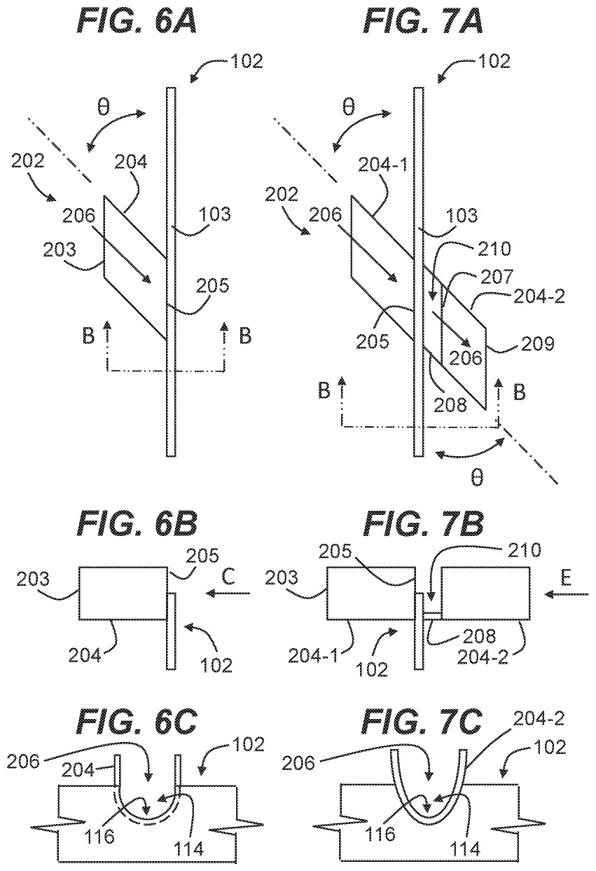

In some embodiments as shown in FIGS. 6A-6C, the stem holder 202 is single-sided. FIG. 6A shows a topside view of the stem holder 202 coupled to the blade 106. As shown, the body 204 of the stem holder 202 is located on a first side of the blade 106 (e.g., on the left side), and in some embodiments, the second end 205 of the holder 202 is coupled directly to the first side of the blade 106.

FIG. 6B shows the stem holder 202 and blade 106 taken from the perspective of cutlines B-B in FIG. 6A, and FIG. 6C shows the stem holder 202 and blade 106 taken from the perspective of arrow C in FIG. 6B.

In some embodiments, as shown in FIG. 6C, the first blade 102 and its cutting edge 103 include a cutout 114 in the area where the first end 103 of the stem holder 202 is coupled to the cutting edge 103. In some embodiments, the shape (e.g., curvature) of the cutout 114 is chosen to generally match the curvature of the stem holder's upper channel 206. In this way, a stem held in the upper channel 206 may extend from the channel 206 through the cutout 114 in the blade 102 to an opposite side of the blade 102.

In some embodiments, the upper facing edge 116 of the cutout 114 is preferably sharpened to facilitate the cutting of a stem extending through the cutout 114 during use. Accordingly, in these embodiments, the upper facing edge 116 essentially becomes a portion of the first blade's cutting edge 103. The cutting edge 105 of second blade 106 is adapted to engage the sharpened upper facing edge 116 (acting as a portion of the first blade's cutting edge 103) to make the cut.

It also is contemplated that the upper channel 206 is coupled to the first blade 102 using a support structure such that the second end 205 of the stem holder 202 is not abutted directly to the cutting edge 103. The support structure may resemble the support structure 208 as described below such that the details of the support structure 208 also apply to this embodiment.

In some embodiments, as shown in FIGS. 7A-7C, the stem holder 202 is double-sided. FIG. 7A shows a topside view of the stem holder 202 configured with the blade 102. As shown, the body 204 of the stem holder 202 includes a first portion 204-1 (that generally corresponds to the body 204 of FIG. 6A) located on a first side of the blade 106 (e.g., on the left side), and a second portion 204-2 located on a second side of the blade 102 opposite the first side (e.g., the right side). The second portion 204-2 includes a first end 207 facing the blade 102 and a second end 209 extending away from the blade 102. In this embodiment, the first and second portions 204-1, 204-2 are aligned such that the upper channel 206 within each portion 204-1, 204-2 also are aligned. In this way, a stem held within the first portion 204-1 may extend directly into the second portion 204-2 without a need to bend or otherwise redirect the stem.

FIG. 7C shows the stem holder 202 and blade 102 taken from the perspective of arrow E in FIG. 7B. FIG. 7C also shows the cutout 114 formed (preferably sharpened) in the cutting edge 103 of the blade 102 to accommodate the upper channel 206 of the stem holder body 204.

In the embodiments of FIGS. 7A-7C, the stem holder's second portion 204-2 is connected to the first blade 102 by a bottom support 208, such as a beam, bracket, and/or other type(s) of support structures. This configuration forms a slot 210 between the stem holder's second portion 204-2 and the cutting edge 103 of the first blade 102 adapted to receive the second blade 106 and its cutting edge 105 during use. The cutting edge 105 of the second blade 106 may engage the cutting edge 103 of the first blade 102 within the slot 210 so that a plant stem residing in the upper channel 206 may be cut. In addition, in some embodiments, the cutting edge 105 of the second blade 106 may engage with the top surface of the bottom support 208. If this happens, the top surface of the bottom support 208 may act as an anvil to facilitate the cutting of the plant stem by the second blade 106.

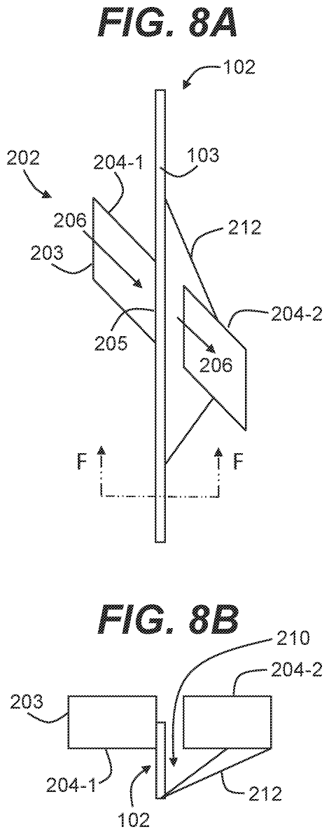

In another embodiment of a double-sided stem holder 202 as shown in FIGS. 8A-8B, the stem holder's second portion 204-2 is connected to the first blade 102 by a lower support 212. FIG. 8B shows the stem holder 202 and blade 102 taken from the perspective of cutlines F-F in FIG. 8A. Notably, that the lower support 212 as shown in FIG. 8B is located lower with respect to the first blade 102 than the bottom support 208 is as shown in FIG. 7B. By placing the lower support 212 in this fashion, the slot 210 is extended downward to better ensure that the cutting edge 105 of the second blade 106 may adequately engage (and pass over) the cutting edge 103 of the first blade 102 during use. Accordingly, it may be preferable that the cutting edge 105 of the second blade 106 not engage the top surface of the lower support 212 as it may in the embodiment of FIG. 7B.

In some embodiments as shown in FIGS. 6A-6C, 7A-7C, and 8A-8B, the plant stem holder body 204 and its channel 206 are oriented at an angle θ with respect to the first blade 102. In some embodiments, 8 equals about 30°-60° and preferably about 45°. However, other angles also are contemplated. In this way, a plant stem placed in the channel 206 of the plant stem holder body 204 is held at the desired angle θ (e.g., at 45°) during the cutting process.

In Use

To use the plant stem cutting assembly 10, a user simply places the stem of a plant to be cut into the channel 206 of the plant stem holder body 204 and closes the first and second blades 102, 106 of the cutting assembly 10 together. During this procedure, the blades 102, 106 (and the removable cutting edge 110 if it exists) engage one another to make the cut. By being held at an offset angle θ within the channel 206 with respect to the cutting blades 102, 106, the plant stem is cut at the desired angle θ.

It also is contemplated that the plant stem holder 202 may include an upper portion (e.g., a latch or cap) that may be closed over the open top of the channel 206 during use to hold the plant stem in place within the channel 206. In this way, the upper portion may help hold the plant stem in place within the channel 206 during the cutting process.

It is understood that the elements of the assembly 10 with respect to the first and second blades 102, 106 may be reversed, e.g., so that the plant stem holder 200 is configured with the second blade 106 instead of the first blade 102.

It is understood that any aspect and/or element of any embodiment of the assembly 10 described herein or otherwise may be combined in any way with any other aspect and/or element of any other embodiment to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A stem cutting device comprising:
a first cutting edge and a second cutting edge adapted to pivotably engage about a pivot point;
a first stem holder comprising a first channel with a first end and a second end defining a first channel longitudinal axis, the first channel including an open top extending between the first end and the second end, the second end of the first channel coupled to the first cutting edge at a first coupling point;
wherein the first channel longitudinal axis is oriented at a first angle with respect to the first cutting edge.

2. The stem cutting device of claim 1 wherein the second end of the first channel includes a first cross-sectional curvature, and the first cutting edge includes a cutout at the first coupling point that corresponds to the first cross-sectional curvature.

3. The stem cutting device of claim 2 wherein the cutout is sharpened.

4. The stem cutting device of claim 1 wherein the first angle is 30°-60°.

5. The stem cutting device of claim 1 wherein the first angle is about 45°.

6. The stem cutting device of claim 1 wherein the first channel is formed by a first half round tube.

7. The stem cutting device of claim 1 further comprising:
a second stem holder comprising a second channel with a third end and a fourth end defining a second channel longitudinal axis and an open top extending between the third end to the fourth end, the third end of the second channel coupled to the first cutting edge.

8. The stem cutting device of claim 7 wherein the second end of the first channel includes a first cross-sectional curvature, and the first cutting edge includes a cutout at the first coupling point that corresponds to the first cross-sectional curvature, and the third end of the second channel includes a second cross-sectional curvature that corresponds to the first cross-sectional curvature.

9. The stem cutting device of claim 7 wherein the second end of the first channel is coupled to a first side of the first cutting edge and the third end of the second channel is coupled to a second side of the first cutting edge, the second side opposite the first side.

10. The stem cutting device of claim 7 wherein the second channel longitudinal axis is parallel to the first channel longitudinal axis.

11. The stem cutting device of claim 7 wherein the second channel longitudinal axis is aligned with the first channel longitudinal axis.

12. The stem cutting device of claim 7 wherein the third end of the second channel is coupled to the first cutting edge using a first support extending between the second channel's third end and the first cutting edge.

13. The stem cutting device of claim 12 wherein the first support forms a gap between the first cutting edge and the third end of the second channel.

14. The stem cutting device of claim 12 wherein the first support is located below the second channel.

15. The stem cutting device of claim 1 wherein the second end of the first channel is coupled directly to the first cutting edge at the first coupling point.

16. The stem cutting device wherein the second cutting edge includes a removable cutting edge.

17. The stem cutting device of claim 16 wherein the removable cutting edge includes a razor blade.

18. The stem cutting device of claim 17 wherein the second cutting edge includes a removable cutting edge holder.

19. The stem cutting device of claim 18 wherein the removable cutting edge holder includes a lock adapted to releasable attach the removable cutting edge to the removable cutting edge holder.

20. The stem cutting device of claim 19 wherein the lock pivots upward to release the removable cutting edge and downward to lock the removable cutting edge.
